(19) United States
(12) Patent Application Publication
(10) Pub. No.: US 2010/0262295 A1
(43) Pub. Date: Oct. 14, 2010

(54) REFRIGERATOR CONTROL TECHNOLOGY

(75) Inventor: Wook Yong LEE, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/758,170

(22) Filed: Apr. 12, 2010

(30) Foreign Application Priority Data
Apr. 13, 2009 (KR) 10-2009-0031646

(51) Int. Cl. G05B 15/00

(52) U.S. Cl. 700/275

(57) ABSTRACT

Refrigerator control technology, in which cool air is supplied to an ice making chamber provided in a refrigerator. The refrigerator senses whether an ice storage basket is attached or detached, whether the ice storage basket is full of ice or not, and/or whether a refrigerator door is opened or closed. Based on the sensing, the refrigerator controls ice removal operations from the ice making chamber to the ice storage basket, ice dispensing operations from the ice storage basket, and/or cool air supply to the ice making chamber.

### CROSS REFERENCE TO RELATED APPLICATIONS

The present application claims priority under 35 U.S.C. 119 and 35 U.S.C. 365 to Korean Patent Application No. 10-2009-0031646 (filed on Apr. 13, 2009), which is hereby incorporated by reference in its entirety.

### FIELD

This disclosure relates to refrigerator control technology.

### BACKGROUND

Generally, a refrigerator is provided with a plurality of storage chambers for preserving stored goods. A refrigerating chamber for preserving the stored goods in a refrigerated state and a freezing chamber for preserving the stored goods in a frozen state are included in the storage chambers. One surface of the storage chamber is opened so that the stored goods can be taken out. And, refrigerator doors that selectively close the storage chambers are provided at one side of the storage chambers.

Meanwhile, an apparatus for making ice may be provided in the freezing chamber. In the related art, in order to make ice, a user should supply water to an ice making tray, store it in a freezing chamber, and then separate ice from the ice making tray after a predetermined time elapses.

In other words, the user should go through troublesome processes for obtaining ice, having a disadvantage that use convenience is decreased.

Moreover, in a state where the refrigerator door is opened, cool air supplied to the storage chamber is leaked to the outside, having a problem that refrigeration efficiency is lowered.

### SUMMARY

In one aspect, a method of controlling a refrigerator includes controlling a fan to promote movement of cool air to an ice making chamber in which an ice maker is installed and controlling the ice maker to freeze liquid water into ice. The method also includes using a sensing apparatus to sense whether an ice storage basket is attached or detached at a door that is configured to open and close at least a portion of a storage chamber in which the ice making chamber is positioned. The method further includes determining whether the ice storage basket is attached or detached at the door based on results of the sensing by the sensing apparatus and driving a first ice removing motor to remove ice made in the ice maker to the ice storage basket conditioned on a determination that the ice storage basket is sensed as being attached at the door by the sensing apparatus.

Implementations may include one or more of the following determining whether a signal transmitted by a transmitting part is received by a receiving part. The method also may include determining whether a sensing member and a contact member contact.

In some implementations, the method may include controlling a door sensing apparatus to sense whether the door is oriented in an opened position or a closed position and determining whether the door is oriented in the opened position or the closed position based on results of the sensing by the door sensing apparatus. In these implementations, the method may include controlling a fan to promote movement of cool air to the ice making chamber conditioned on a determination that the door is oriented in the closed position.

In addition, the method may include controlling an open/close member to open a passage that supplies cool air to the ice making chamber conditioned on a determination that the door is oriented in the closed position. Further, the method may include controlling the first ice removing motor to be turned off irrespective of the determination of whether the ice storage basket is attached or detached in response to a determination that the door is oriented in the opened position. The method may include driving a second ice removing motor to dispense ice stored in the ice storage basket through the door conditioned on a determination that the ice storage basket is sensed as being attached at the door by the sensing apparatus.

In another aspect, a method of controlling a refrigerator includes controlling an ice maker to freeze liquid water into ice, sensing a level of ice stored in an ice storage basket configured to store ice made by the ice maker, and determining whether the ice storage basket is full of ice based on the sensed level of ice stored in the ice storage basket. The method also includes sensing a position of the ice storage basket at a door that is configured to open and close at least a portion of a storage chamber in which the ice maker is positioned and determining whether the ice storage basket is attached or detached at the door based on the sensed position of the ice storage basket. The method further includes driving an ice removing motor to remove ice made in the ice maker to the ice storage basket conditioned on a determination that the ice storage basket is attached at the door and a determination that the ice storage basket is not full of ice.

Implementations may include one or more of the following features. For instance, the method may include controlling a transmitting part to transmit a signal across the ice storage basket toward a receiving part, and determining that the ice storage basket is full of ice when the transmitted signal is not received by the receiving part.

In some examples, the method may include controlling a door sensing apparatus to sense whether the door is oriented in an opened position or a closed position and determining whether the door is oriented in the opened position or the closed position based on results of the sensing by the door sensing apparatus. In these examples, the method may include controlling the ice removing motor to be turned off irrespective of the determination of whether the ice storage basket is full of ice in response to a determination that the door is oriented in the opened position.

In yet another aspect, a method of controlling a refrigerator includes controlling an ice maker to freeze liquid water into ice, controlling a transmitting part to transmit a signal, and determining whether a receiving part receives the signal transmitted from the transmitting part. The method also includes determining, using a controller, whether an ice storage basket is positioned to receive ice made by the ice maker and whether the ice storage basket is full of ice based on the determination of whether the receiving part receives the signal transmitted from the transmitting part.

Implementations may include one or more of the following features. For example, the method may include driving an ice removing motor to remove ice made in the ice maker to the ice storage basket in response to a determination that the ice storage basket is positioned to receive ice made by the ice maker and the ice storage basket is not full of ice. The method also may include driving an ice removing motor to dispense ice stored in the ice storage basket to an outside of the refrigerator conditioned on a determination that the ice storage basket is positioned to receive ice made by the ice maker.

In addition, the method may include driving a fan to promote movement of cool air to the ice maker conditioned on a determination that the ice storage basket is positioned to receive ice made by the ice maker. The method further may controlling an open/close member to open a passage that supplies cool air to the ice maker conditioned on a determination that the ice storage basket is positioned to receive ice made by the ice maker.

In some examples, the method may include controlling a door sensing apparatus to sense whether a refrigerator door is oriented in an opened position or a closed position and determining whether the refrigerator door is oriented in the opened position or the closed position based on results of the sensing by the door sensing apparatus. In these examples, the method may include driving an ice removing motor to remove ice made in the ice maker to the ice storage basket conditioned on a determination that the refrigerator door is oriented in the closed position, a determination that the ice storage basket is positioned to receive ice made by the ice maker, and a determination that the ice storage basket is not full of ice.

The method also may include driving an ice removing motor to dispense ice stored in the ice storage basket to an outside of the refrigerator conditioned on a determination that the refrigerator door is oriented in the closed position and a determination that the ice storage basket is positioned to receive ice made by the ice maker. The method further may include driving a fan to promote movement of cool air to the ice maker conditioned on a determination that the refrigerator door is oriented in the closed position and a determination that the ice storage basket is positioned to receive ice made by the ice maker. The method may include controlling an open/close member to open a passage that supplies cool air to the ice maker conditioned on a determination that the refrigerator door is oriented in the closed position and a determination that the ice storage basket is positioned to receive ice made by the ice maker.

In another aspect, a method of controlling a refrigerator includes controlling a fan to promote movement of cool air to an ice making chamber in which an ice maker is installed and controlling the ice maker to freeze liquid water into ice. The method also includes using a first sensing apparatus to sense whether an ice storage basket is attached or detached at a door that is configured to open and close at least a portion of a storage chamber in which the ice making chamber is positioned, using the first sensing apparatus to sense whether the ice storage basket is full of ice, and using a second sensing apparatus to sense whether the door is oriented in an opened position or a closed position. The method further includes driving a first ice removing motor to remove ice made in the ice maker to the ice storage basket conditioned on the second sensing apparatus sensing that the door is oriented in the closed position and the first sensing apparatus sensing that the ice storage basket is not full of ice and driving a second ice removing motor to dispense ice stored in the ice storage basket to the through the door conditioned on the first sensing apparatus sensing that the ice storage basket is attached at the door.

### BRIEF DESCRIPTION OF THE DRAWINGS

FIG. 1 is a front view showing an external appearance of a refrigerator;

FIG. 2 is a perspective view showing an inner appearance of the refrigerator;

FIG. 3 is a perspective view showing an inner configuration of an ice storage unit;

FIG. 4 is a perspective view showing an inner configuration of a housing;

FIG. 5 is a cross-sectional view taken along line I-I′ of FIG. 2;

FIG. 6 is a cross-sectional view showing an appearance where a storage basket is separated;

FIG. 7 is a diagram showing an operation of the refrigerator;

FIG. 8 is a block diagram showing a configuration of the refrigerator;

FIG. 9 is a cross-sectional view showing a configuration of an ice storage unit;

FIG. 10 is a cross-sectional view showing an appearance where a storage basket is separated;

FIG. 11 is a diagram showing a configuration of a refrigerator;

FIG. 12 is a block diagram showing a configuration of the refrigerator;

FIG. 13 is a diagram showing a configuration of a refrigerator;

FIGS. 14 and 15 are flowcharts showing a method for controlling a refrigerator; and

FIG. 16 is a flowchart showing a method for controlling a refrigerator.

### DETAILED DESCRIPTION

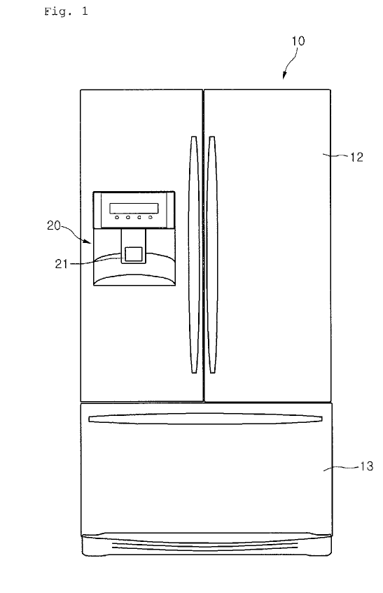

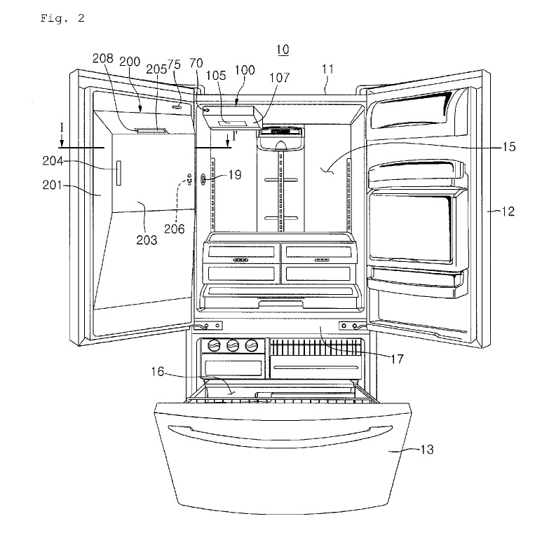

FIG. 1 illustrates an example of a refrigerator, and FIG. 2 illustrates an example interior of the refrigerator shown in FIG. 1.

Referring to FIGS. 1 and 2, a refrigerating chamber 15 and a freezing chamber 16 are defined in a main body 11 of the refrigerator 10. The refrigerating chamber 15 is defined on the upper portion of the freezing chamber 16. The refrigerating chamber 15 and the freezing chamber 16 may be partitioned by a barrier 17 (e.g., a barrier rib, a barrier wall, etc.).

The refrigerating chamber 15 is selectively closed by a refrigerating door 12 that is installed at the main body 11 and configured to rotate back and forth about a hinge to open and close a portion of the refrigerating chamber 15. And, the freezing chamber 16 is opened and closed by a freezing chamber door 13 drawably installed at the main body 11 in a drawer type. The refrigerating chamber door 12 may include multiple doors, such as french doors.

A dispenser 20 that dispenses water and/or ice is provided at the front surface of the refrigerating chamber door 12. The dispenser 20 includes a lever 21 that may be pressed to cause the dispenser 20 to dispense water and/or ice.

Moreover, an ice making chamber 100 that makes ice is provided in the main body 11. The ice making chamber 100 may be positioned at one side of the upper end of the refrigerating chamber 15. And, an ice discharge hole 105 that discharges ice made in the ice making chamber 100 is defined at the front surface of the ice making chamber 100.

A slanted surface 107 is defined at the front lower end of the ice making chamber 100. The slanted surface 107 of the ice making chamber 100 may be defined as at least a portion of the front surface of the ice making chamber 100 and may be downwardly slanted to the rear of the refrigerating chamber 15.

An ice storage part 200 that stores the ice discharged from the ice making chamber 100 through the ice discharge hole 105 is provided at the refrigerating chamber door 12. The ice storage part 200 is disposed at the backside of the refrigerating chamber door 12. Therefore, the ice storage part 200 communicates with the ice making chamber 100 in a state where the refrigerating chamber door 12 is closed and separates from the ice making chamber 100 in a state where the refrigerating chamber door 12 is opened.

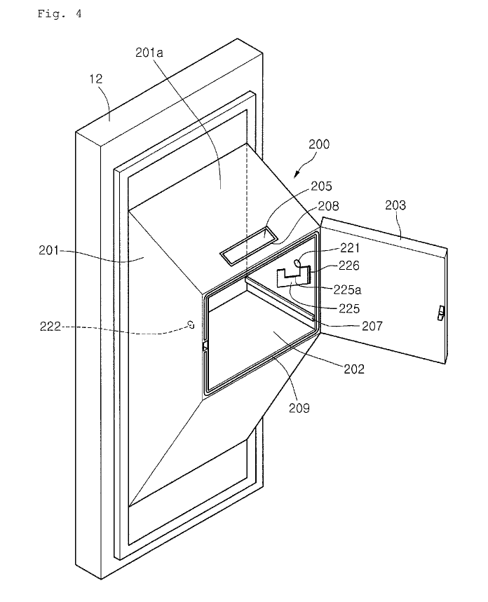

The ice storage part 200 includes a housing 201 provided with a receiving space 202 (see FIG. 4) that receives a storage basket 210 (described in more detail below) and a door 203 that selectively opens and closes the receiving space 202 of the housing 201. The housing 201 may be formed of material with high insulation so that heat-exchange between the receiving space 202 and the refrigerating chamber 15 can be reduced (e.g., minimized). Furthermore, the door 203 may be rotatably installed in a predetermined direction of the housing 201, for example, centering on the vertical shaft.

An ice inlet part 205 into which the ice discharged from the ice discharge hole 105 flows is defined at the housing 201. The ice inlet part 205 may be have a shape and size corresponding to the ice discharge hole 105.

In addition, a gasket 208 may be provided at the edge portion of the ice inlet part 205. The gasket 208 reduces (e.g., prevents) the cool air of the ice making chamber 100 or the ice storage part 200 from being leaked in a state where the ice discharge hole 105 is closely adhered to the ice inlet part 205. The gasket also may be provided at the edge portion of the ice discharge hole 105.

A slanted surface 201a is defined at the upper surface portion of the housing 201. If the refrigerating chamber door 12 is closed, the slanted surface 201a of the housing 201 may be closely adhered to the slanted surface 107 of the ice making chamber 100. To this end, the slanted surface 201a of the housing 201 is downwardly slanted to the rear of the refrigerating chamber 105, at the same angle as the slanted surface of the ice making chamber 100.

A door handle 204 which a user grips for opening and closing the door 203 is positioned at the door 203. The door handle 204 may represent a collapsed portion of the door 203.

In some examples, a hanging hook and a hanging groove may be provided as a locking apparatus for maintaining a state where the door 203 closes the receiving space 202 of the housing 201. For example, the hanging hook provided at the door 203 is hung with the hanging groove provided at the housing 201, making it possible to maintain a state where the door 203 closes the receiving space 202 of the housing 201.

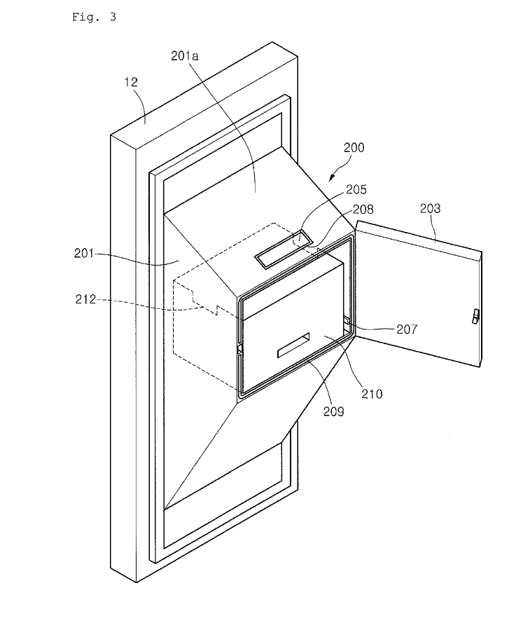

A sealing member 209 (see FIG. 3) may be provided at the edge of one opened surface of the housing 201. The sealing member 209 may be closely adhered to the door 203 in a state where the receiving space 202 of the ice storage part 200 is closed by the door 203.

Moreover, a cool air discharge hole 206 that discharges the cool air supplied to the ice storage part 200 is defined on one side of the housing 201. For instance, the cool air that flows into the ice storage part 200 from the ice making chamber 100 can be discharged through the cool air discharge hole 206.

A cool air inlet hole 19 receives the cool air discharged from the cool air discharge hole 206 and is defined at the main body 11 corresponding to one side of the refrigerating chamber 15. The cool air inlet hole 19 may be defined at the position where it communicates with the cool air discharge hole 206 in a state where the refrigerating chamber door 12 is closed. The cool air inlet hole 19 separates from the cool air discharge hole 206 in a state where the refrigerating chamber door 12 is opened. The cool air flowed into through the cool air inlet hole 19 may be guided to the freezing chamber 16 through a duct positioned in a side wall of the refrigerating chamber 15 that passes the barrier 17.

Meanwhile, referring to FIG. 2 again, a door switch 70 that senses whether the refrigerating chamber door 12 is opened or closed may be provided on an outer side of the ice making chamber 100. The door switch 70 may be projected from the front surface of the ice making chamber 100 to the front.

Further, a switch lever 75 that contacts the door switch 70 in a state where the refrigerating chamber door 12 is closed is provided at the backside of the refrigerating chamber door 12. The switch lever 75 is projected from the inside of the refrigerating chamber door 12.

Although the door switch 70 is shown to be provided in the ice making chamber 100 in FIG. 2, the door switch 70 may be disposed at the barrier 17 that partitions the refrigerating chamber 15 and the freezing chamber 16. And, the switch lever 75 may be disposed at the lower portion of the inside of the refrigerating chamber door 12 according to the position of the door switch 70. In some implementations, the switch lever 75 may be omitted and the switch 70 may be directly pressed by the refrigerating chamber door 12.

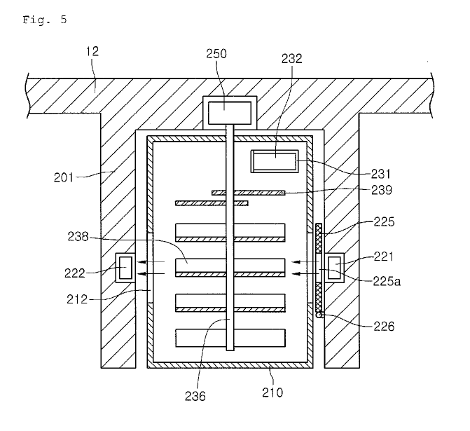

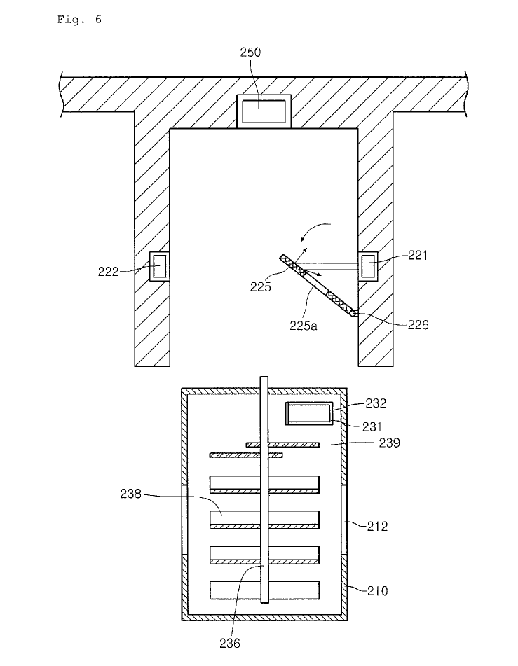

FIGS. 3 and 4 illustrate examples of an ice storage part, FIG. 5 illustrates an example of a cross-sectional view taken along lines I-I′ of FIG. 2, and FIG. 6 illustrates an example where the storage basket is separated from the ice storage part.

Referring to FIGS. 3 to 6, the ice storage part 200 includes a housing 201 provided at the backside of the refrigerating chamber door 12, a door 203 that selectively opens and closes the receiving space 202 of the housing 201, and a storage basket 210 that is installed in a manner that allows the storage basket 210 to slide or be drawn to the inside/outside of the housing.

A predetermined storage space where ice is stored is provided inside the storage basket 210. For example, the storage basket 210 may have a rectangular parallelepiped shape of which an upper surface is opened to receive ice. And, a signal transmission part 212 is defined in the storage basket 210. The signal transmission part 212 is the place where light (signals) generated from a transmitting part 221 is transmitted to be transferred to a receiving part 222. For example, the signal transmission part 212 may be defined by cutting or collapsing a portion of the storage basket 210 to allow the light (signals) generated from the transmitting part 221 to be transferred to the receiving part 222 without interference by the storage basket 210.

A guide rail 207 that guides the drawing/accepting of the storage basket 210 is provided at the inner surface of the housing 201. The guide rail 207 may be provided in plural at both sides of the housing 201. Guide parts moving along the guide rails 207 may be provided at both sides of the storage basket 210.

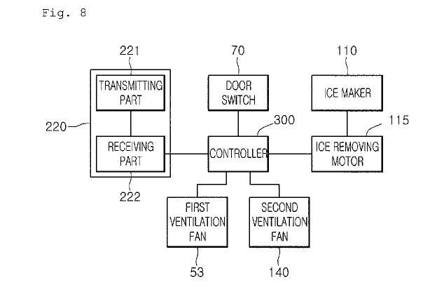

Moreover, a receiving space 202 that receives the storage basket 210 is provided inside the housing 201. For example, the storage basket 210 is drawn/accepted to the inside/outside of the receiving space 202. The guide rails 207 may be provided at both sides of the receiving space 202. Sensors 220 that sense whether the storage basket 210 is coupled (see FIG. 8) are provided at the inner surfaces of the housing 201 facing each other. The sensor 220 includes a transmitting part 221 and a receiving part 222. The transmitting part 222 is provided at one of the inner surfaces of the housing 201 to transmit light (signals). The receiving part 222 is provided at the other of the inner surfaces of the housing 201 to receive the light (signals) transmitted from the transmitting part 221. In a state where the storage basket 210 is received in the receiving space 202 of the housing 201, the transmitting part 221 and the receiving part 222 may be provides at the position corresponding to the signal transmission part 212 of the storage basket 210.

Furthermore, a blocking member 225 is provided on one side of the transmitting part 221. The blocking member 225 blocks the signals transmitted from the transmitting part 221 from being received by the receiving part 222 in a state where the storage basket 210 is drawn out to the outside of the receiving space 202. An incision part 225a collapsed in one direction is defined in the blocking member 225. The transmitting part 221 may be provided on one side of the incision part 225a.

The incision part 225a is shown to be collapsed from the upper end of the blocking member 225 to the lower end thereof in FIG. 4, but the incision part 225a also may be defined to be collapsed from the lower end of the blocking member 225 or one side thereof. The shape of the blocking member 225 is not limited to the shape shown in FIGS. 4 to 6.

And, although the blocking member 225 is described to be provided on one side of the transmitting part 221, the blocking member 225 also may be provided on one side of the receiving part 222 or may be provided on the transmitting part 221 and the receiving part 222, respectively.

The blocking member 225 may be rotatably coupled to the housing 201. And, a first spring 226 that gives elasticity so that the blocking member 225 is rotated in the direction that the blocking member 225 blocks the transmission/receipt of the signals between the transmitting part 221 and the receiving part 222 is provided on one side of the blocking member 225. For example, a torsion spring that allows the blocking member 225 to be rotated at a predetermined range may be used as the first spring 226.

An outlet 231 from which the stored ice is taken out and a shutter 232 that selectively opens and closes the outlet 231 are provided in the storage basket 210. For example, the shutter 232 can open the outlet 231, if the lever 21 is pressed in order to take out the ice through the dispenser 20.

Furthermore, augers 238 that are rotatably provided so that the stored ice is moved to the outlet 231 side and a rotation shaft 236 that provides a rotation center of the augers 238 are included inside the storage basket 210. The rotation shaft 236 is disposed to penetrate through the augers 238 so that it can be rotated with the augers 238.

A motor 250 that provides driving force for rotating the rotation shaft 236 is provided in the refrigerating chamber door 12. If the storage basket 210 is coupled to the housing 201, the rotation shaft 236 can be connected to the motor 250.

The storage basket 210 also includes an ice cutting device 239. The ice cutting device 239 is configured to cut or crush stored ice cubes into smaller pieces prior to being dispensed when the dispenser 20 is controlled to dispense cut or crushed ice.

Hereinafter, the operation related to the attachment/detachment of the storage basket will be described.

In a state where the storage basket 210 is drawn out to the outside of the receiving space 202 of the housing 201, the blocking member 225 blocks the transmission/receipt of the signals between the transmitting, part 221 and the receiving part 222 by the elasticity of the first spring 226. If the storage basket 210 is received in the receiving space 202 of the housing 201 in such a state, the storage basket 210 pressurizes the blocking member 225. Therefore, the blocking member 225 overcomes the elasticity of the first spring 226 to be rotated in the position to block the transmission/receipt of the signals between the transmitting part 221 and the receiving part 222.

As shown in FIG. 5, the blocking member 225 is arranged forward and backward in a state where it is positioned between the storage basket 210 and the housing 201 so that the transmission/receipt of the signals between the transmitting part 221 and the receiving part 222 can be performed.

At this time, centering on the incision part 225a of the blocking member 225, the transmitting part 221 is positioned at one side and the signal transmission part 212 of the storage basket 210 is positioned at the other side. For instance, the signals transmitted from the transmitting part 221 can be received by the receiving part 222 via the incision part 225a and the signal transmission part 212.

Consequently, the signals transmitted from the transmitting part 221 can be received by the receiving part 222. And, the signals received by the receiving part 222 are transferred to a controlling part 300 (see FIG. 8) and the controlling part 300 is able to recognize the coupling with the storage basket 210.

Therefore, the controlling part 300 can control ice removal from the ice making chamber 100 because the storage basket 210 is in position to receive the removed ice.

Meanwhile, if the storage basket 210 is drawn out, the rotation shaft 236 is separated from the motor 250. And, if the storage basket 210 is completely drawn out, the force pressing the blocking member 225 is removed. Therefore, the blocking member 235 is rotated by the elasticity of the first spring 226 to be positioned so that the transmission/receipt of the signals between the transmitting part 221 and the receiving part 222 are blocked. Referring to FIG. 6, the blocking member 225 can be rotated in a counterclockwise direction, centering on the first spring 226. Therefore, the controlling part 300 recognizes the drawing-out of the storage basket 210, thereby making it possible to stop removing ice from the ice making chamber 100.

Meanwhile, the sensor 220 including the transmitting part 221 and the receiving part 222 will sense whether the storage basket 210 is full with ice. In this case, the blocking member 225 may not be provided.

If the height of ice stored in the storage basket 210 is raised up to the height of the transmitting part 221 and the receiving part 222, the signals transmitted from the transmitting part 221 are interfered or reflected by the ice surface, thereby not being transferred to the receiving part 222. And, if the transmission/receipt of the signals between the transmitting part 221 and the receiving part 222 is blocked, the controlling part 300 senses the ice fullness of the storage basket 210, making it possible to stop removing ice from the ice making chamber 100.

The reference to determine that the ice in the storage basket 210 is full may be changed according to the installation height of the transmitting part 221 and the receiving part 222.

In some examples, whether the storage basket 210 is attached or detached and whether the ice inside storage basket 210 is full with ice also can be sensed by the sensor 220. For example, at least a portion of the storage basket 210 may be molded of material that can transmit the signals transmitted from the transmitting part 221. Therefore, the transmission/receipt of the signals between the transmitting part 221 and the receiving part 222 is performed depending on whether the storage basket 210 is attached or detached by the blocking member 225, making it possible to sense whether the storage basket 210 is attached or detached. When the ice stored in the storage basket 210 is at a full level, the transmission/receipt of the signals between the transmitting part 221 and the receiving part 222 is blocked by the ice stored in the storage basket 210, making it possible to sense whether the ice in the storage basket 210 is at the full level.

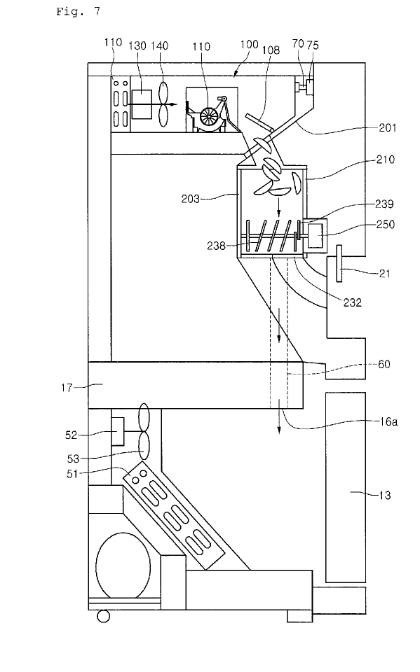

FIG. 7 illustrates an example of the operation of the refrigerator. Referring to FIG. 7, a first heat-exchanger 51, a first fan motor 52, and a first fan 53 are provided in the rear of the freezing chamber 16. The first heat-exchanger 51 generates cool air to be supplied to the freezing chamber 16. And, the first fan motor 52 and the first fan 53 promote movement of (e.g., blow or flow) the cool air generated in the first heat exchanger 51 to the freezing chamber 16.

An ice maker 110 that makes ice from supplied water is installed in the ice making chamber 100. And, a second heat exchanger 120 is installed inside the ice making chamber 100. The second heat-exchanger 120 generates cool air through heat-exchange with air inside the ice making chamber 100. A second fan motor 130 and a second fan 140 that promote movement of (e.g., blow or flow) the cool air generated in the second heat-exchanger 120 to the ice maker 110 are provided inside the ice making chamber 100.

An ice tray that is supplied with water to make ice in a predetermined shape and an ice removing motor 115 (see FIG. 8) that is driven to remove ice from the ice tray are included in the ice maker 110. A heater that separates ice may be provided in the ice tray. If the ice removing motor 115 is driven, the ice separated from the ice tray is fallen to the storage basket 210 to be stored.

An obstruction member 108 (e.g., a shutter) opens and closes the ice discharge hole 105. When the obstruction member 108 opens the ice discharge hole 105, ice and/or cool air is allowed to pass from the ice making chamber 100 and through the ice discharge hole 105. When the obstruction member 108 closes the ice discharge hole 105, ice and/or cool air is obstructed from passing out of the ice making chamber 100 and through the ice discharge hole 105.

The obstruction member 108 may be controlled based on opening and closing of the door 12. For example, when the controller 300 detects the door 12 as being oriented in a closed position, the controller 300 may control the obstruction member 108 to open the ice discharge hole 105, thereby allowing ice and/or cool air flow through the ice discharge hole 105. When the controller 300 detects the door 12 as being oriented in an opened position, the controller 300 may control the obstruction member 108 to close the ice discharge hole 105, thereby obstructing ice and/or cool air flow through the ice discharge hole 105.

In some implementations, the obstruction member 108 may be controlled based on output of the sensor 220. For example, when the controller 300 detects the storage basket 210 as being in position and able to receive additional ice based on output from the sensor 220, the controller 300 may control the obstruction member 108 to open the ice discharge hole 105, thereby allowing ice flow through the ice discharge hole 105. When the controller 300 detects the storage basket 210 as being removed or full of ice based on output from the sensor 220, the controller 300 may control the obstruction member 108 to close the ice discharge hole 105, thereby obstructing ice flow through the ice discharge hole 105.

If a user presses the lever 21 to take out the ice through the dispenser 20, the shutter 232 is rotated to open the outlet 231 so that the ice can be discharged to the outside through the dispenser 20.

Meanwhile, the cool air supplied to the ice maker 110 flows into the freezing chamber 16 through the ice storage part 200. More specifically, a return duct 60 is provided between a cool air inlet hole 19 defined in the refrigerating chamber 15 and the freezing chamber 16.

The return duct 60 extends from one side wall of the refrigerating chamber 15 by penetrating through the barrier 17. And, the cool air flowing through the return duct 60 is guided into the freezing chamber 16 through a freezing chamber inlet part 16a.

For example, the cool air inlet hole 19 is defined at one end of the return duct 60 and the freezing chamber inlet part 16a is defined at the other end thereof.

In operation, the cool air passing through the ice maker 110 flows into the return duct 60 through the cool air discharge hole 206 after cooling the storage part 200, thereby being flowed into the inside of the freezing chamber 16 through the freezing chamber inlet part 16a.

FIG. 8 illustrates an example of a refrigerator. Referring to FIG. 8, the refrigerator 10 according to the includes a first fan 53 that flows cool air to the freezing chamber 16 and a second fan 140 that flows cool air to the ice making chamber 100, a sensor that is provided at the refrigerating chamber door 15 to sense whether the storage basket 210 is attached or detached or whether ice therein is at a full level, a door switch 70 that senses whether the refrigerating chamber door 15 is opened or closed, an ice removing motor 115 of which driving is controlled depending on whether the storage basket 210 is attached or detached and/or level of ice stored in the storage basket 210, an ice maker 110 of which ice removing is selectively performed according to the driving of the ice removing motor 115, and a controlling part 300 that is connected to the other components and controls operation of the refrigerator.

More specifically, the first fan 53 and the second fan 140 are controlled separately by the controlling part 300, making it possible to allow cool air to be supplied to the freezing chamber 16 and the ice making chamber 100, respectively.

A transmitting part 221 and a receiving part 222 that transmits and receives signals are included in the sensor 220. If the signals transmitted from the transmitting part 221 are transferred to the receiving part 222, it is determined as a state where the storage basket 210 is coupled or ice is not full in the storage basket 210, thereby being controlled the ice removing to be performed from the ice maker 110. Alternatively, if the signals transmitted from the transmitting part 221 are not transferred to the receiving part 222, it is determined as a state where the storage basket 210 is removed or ice is full in the storage basket 210, thereby being controlled the ice removing to be stopped from the ice maker 110.

Meanwhile, if the closing of the refrigerating chamber door 12 is recognized by the door switch 70, the driving of the second fan 140 is maintained to perform the supply of the cool air to the ice making chamber 100, making it possible to perform ice removing to the ice storage part 200 from the ice maker 110.

Alternatively, if the opening of the refrigerating chamber door 12 is recognized by the door switch 70, the driving of the second fan 140 is stopped to stop the supply of the cool air to the ice making chamber 100, making it possible to reduce (e.g., minimize) leakage of the cool air to the outside of the refrigerator.

Furthermore, the controller 300 controls the ice removing from the ice maker 110 to be stopped, making it possible to reduce (e.g., prevent) a phenomenon that the ice is discharged to the outside of the refrigerator from the ice maker 110.

In some implementations, a different structure may be used to sense the attachment and detachment of the storage basket 210. In describing the different structure, like parts will be referenced by like reference numbers and the different structure will be described in detail.

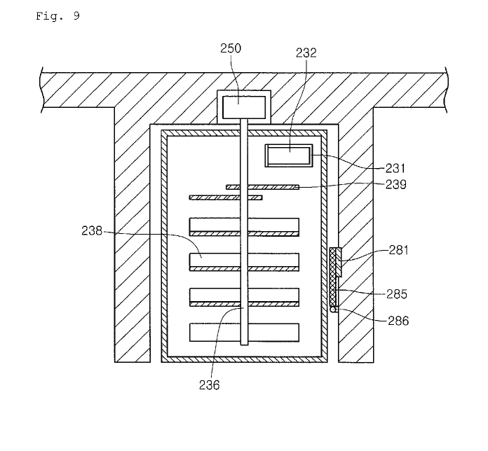

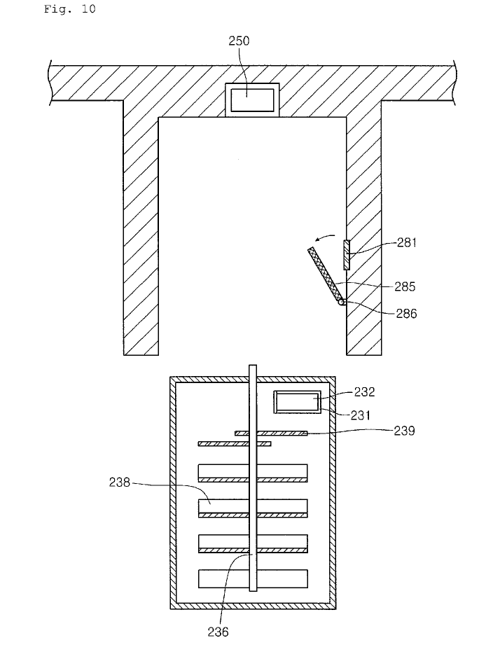

FIG. 9 illustrates an example of an ice storage part, and FIG. 10 illustrates an example where the storage basket is separated.

Referring to FIGS. 9 and 10, an ice storage part 200 that stores ice is included in the refrigerating chamber door 12. And, a housing that defines an internal space for receiving the storage basket 210 is included in the ice storage part 200.

A sensing member 281 that senses whether the storage basket 210 is attached or detached is provided at the inner side of the housing 201. The sensing member 281 may be exposed to the outside, while being coupled to the housing 201. Herein, a switch may be included in the sensing member 281.

Although the sensing member 281 is shown to be provided at only one side of the storage basket 210 in FIG. 9, it also may be provided at both sides (left and right sides) of the storage basket 210 or may be provided at the rear side of the storage basket 210.

A contact member 285 that selectively contacts the sensing member 281 depending on whether the storage basket 210 is drawn in or drawn out is provided at one side of the sensing member 281. The contact member 285 may be coupled rotatably to the housing 201.

Herein, a switch structure that is electrified by the contact may be applied to the sensing member 281 and the contact member 285, wherein they may be collectively referred to as a sensing apparatus.

A second spring 286 that provides an elastic force to the contact member 285 is provided at one side of the contact member 285. The contact member 285 may be coupled to the inner wall of the housing 201 by the second spring 286.

The operation of the storage basket and the attachment/detachment sensing operation will be described in more detail below.

First, in a state where the storage basket 210 is coupled to the housing 201, the contact member 285 is intervened between one side surface of the storage basket 210 and the inner side surface of the housing 201. And, as shown in FIG. 9, the contact member 285 is arranged forward and backward.

At this time, the contact member 285 may be pressurized by the storage basket 210 and the elasticity of the second spring 286 may be offset by the pressurized force.

In a state where the storage basket 210 is drawn in the housing 201, the contact member 285 contacts the sensing member 281 so that the sensing member 285 can sense the coupling state of the storage basket 210.

The sensing signals of the sensing member 285 are transferred to the controlling part 300 so that the controlling part 300 can control the operation of the refrigerator according to the coupling of the storage basket 210. The contents of the operation of the refrigerator are similar to those described above.

Meanwhile, if the storage basket 210 is separated from the housing 201, the contact member 285 is rotated in a predetermined direction by the elasticity of the second spring 286. As shown in FIG. 10, the contact member 285 can be rotated in a counterclockwise direction.

If the contact member 285 is rotated, the contact member 285 is spaced from the sensing member 281 so that the signals by the contact member 258 are disconnected in the sensing member 281.

Thereby, the sensing member 281 senses the separation of the storage basket 210 to transfer it to the controlling part 300. And, the controlling part 300 can control the operation of the refrigerator according to the removal of the storage basket 210. The contents of the operation of the refrigerator are similar to those described above.

In some examples, a different cool air supply structure may be used. In describing the different structure, like parts will be referenced by like reference numbers and the different cool air supply structure will be described in detail.

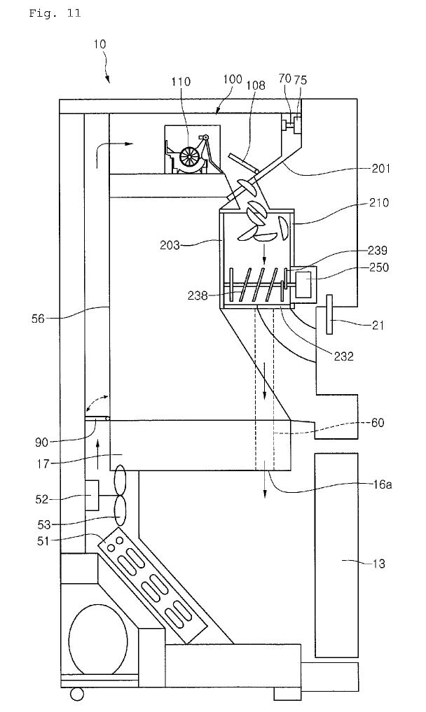

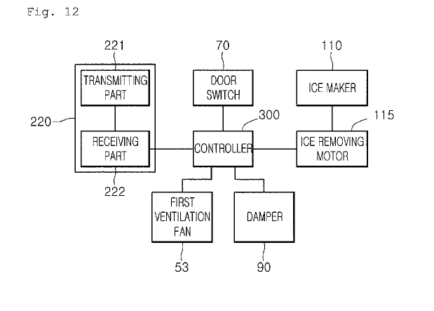

FIGS. 11 and 12 illustrate an example of a refrigerator.

Referring to FIGS. 11 and 12, the refrigerator 10 includes a first heat-exchanger 51 that generates cool air by performing a heat-exchange with external equipment, a first fan 53 that flows the cool air generated in the first heat-exchanger 51 to the freezing chamber 16, and a first fan motor 52.

A cool air duct 56 extends to the refrigerating chamber 15 from one side of the first fan 53 and guides at least a portion of the cool air generated from the first heat-exchanger 51. The cool air duct 56 is provided at the rear side of the barrier 17 that partitions the refrigerating chamber 15 and the freezing chamber 16 and extends to the ice making chamber 100.

At least a portion of the barrier 17 may be open so that the cool air generated in the freezing chamber 16 can be moved to the refrigerating chamber 15.

A damper 90 that selectively blocks the flow of the cool air is provided at one side of the cod air duct 56.

In a state where the damper 90 is opened, at least a portion of the cool air generated in the first heat-exchanger 51 may flow into the ice making chamber 100 through the cool air duct 56. The cool air flowed into the ice making chamber 100 passes through the ice storage part 200, after being used for ice making, thereby returning to the freezing chamber 16 through the return duct 60.

Alternatively, in a state where the damper 90 is closed, the cool air flows into the freezing chamber 16 and does not flow inside the cool air duct 56. As such, the cool air does not flow into the ice making chamber 100 and the ice storage part 200.

In operation, the first fan 53 and the damper 90 can be controlled by the controlling part 300.

If the refrigerating chamber door 12 is opened, the damper 90 is closed and the flow of the cool air inside the cool air duct 56 is blocked so that the supply of cool air to the ice making chamber 100 and the ice storage part 200 may be stopped. Also, in a state where the refrigerating chamber door 12 is opened, a phenomenon that the cool air is unnecessarily leaked to the outside of the refrigerator can be reduced (e.g., prevented).

Alternatively, if the refrigerating chamber door 12 is closed, the damper 90 is opened so that the cool air flows into the ice making chamber 100, as described above.

Meanwhile, ice removing operation of the ice maker 110 is controlled depending on whether the storage basket 210 is attached or detached as described above.

In some implementations, the ice making chamber may have a different position. In describing the different position of the ice making chamber, like parts will be referenced by like reference numbers and differences related to the position will be described in detail.

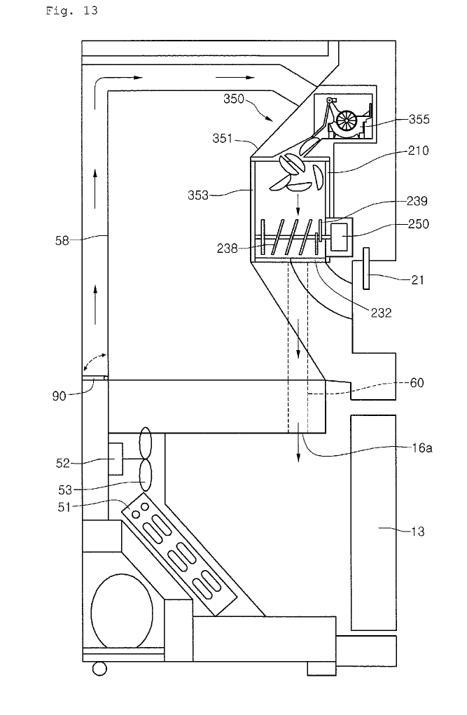

FIG. 13 illustrates an example of a refrigerator.

Referring to FIG. 13, an ice making apparatus 350 includes an ice maker 355 that makes ice and a storage basket 210 in which the ice made in the ice maker 355 is stored. The ice making apparatus 350 is provided at a refrigerating chamber door 12.

A housing 351 that is projected from an inner side surface of the refrigerating chamber door 12 and a door 353 that selectively closes the housing 351 are included in the ice making apparatus 350. And, the ice maker 355 and the storage basket 210 are received inside the housing 351.

A cool air duct 58 is provided in the refrigerating chamber 15. The cool air duct 58 guides cool air generated in the freezing chamber 16. The cool air duct 58 extends to the refrigerating chamber 15 from one side of the freezing chamber 16 by penetrating through the barrier 17.

Herein, the cool air duct 58 extends upward from the rear side of the refrigerating chamber 15 and then is bent forward, thereby being communicated with the ice maker 35.5.

Moreover, a damper 90 that selectively blocks the flow of the cool air is provided in the cool air duct 58.

The damper 90 is coupled rotatably to one side of the cool air duct 58 and closes an internal space of the cool air duct 58, thereby making it possible to block the flow of the cool air.

The cool air generated in the first heat-exchanger 51 flows into the freezing chamber 16 through the fan 53, and at least a portion of the cool air can be supplied to the ice maker 355 through the cool air duct 58.

If the refrigerating chamber door 12 is opened, the door opening signals are transferred to the controlling part 300 by the door switch 70, and the controlling part 300 allows the flow of the cool air to be blocked by rotating the damper 90 to a closed position. Then, the supply of cool air to the ice maker 355 is stopped, making it possible to reduce (e.g., prevent) the cool air from being unnecessarily leaked to the outside of the refrigerator through the opened door.

Alternatively, the damper 90 is controlled to be opened in a state where the refrigerating chamber door 12 is closed. And, after being supplied to the ice maker 355 and the storage basket 210, the cool air is returned to the freezing chamber 16 through the return duct 60.

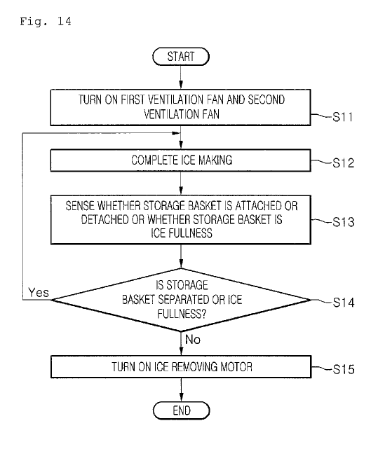

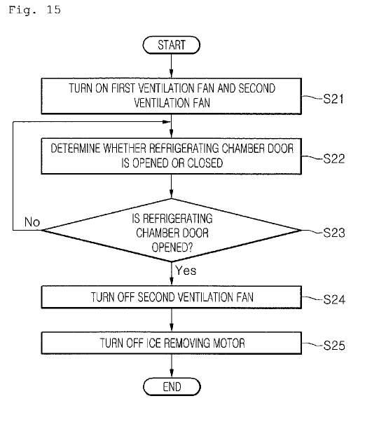

FIGS. 14 and 15 illustrate example methods of controlling a refrigerator.

FIG. 14 illustrates an example method of controlling a refrigerator depending on whether the storage basket 210 is attached or detached or whether the ice stored in the storage basket 210 is at a full level.

The controlling part 300 controls the first fan 53 and the second fan 140 to be turned on. Then, the cool air generated in the first heat-exchanger 51 is supplied to the freezing chamber 16 through the first fan 53, and the cool air generated in the second heat-exchanger 120 is supplied to the ice making chamber 100 through the second fan 140 (S11).

In this state, if the supply of the cool air to the ice making chamber 100 is performed for a predetermined time, the ice making in the ice maker 110 can be completed (S12).

If the ice making is completed, whether the storage basket 210 is attached or detached can be sensed by the sensor 220. Alternately, whether the storage basket 210 is full of ice can be sensed (S13).

If the storage basket 210 is sensed to be separated (removed) from the housing 201, removal of ice from the ice maker 110 is not performed and operation is returned to the step S11. Also (or alternatively), when the storage basket 210 is sensed to be full of ice, removal of ice from the ice maker 110 may be stopped (S14).

If the storage basket 210 is sensed to be coupled to the housing 210, the controlling part 300 controls the ice removing motor 115 to be driven (S15). If the ice removing motor 115 is driven, ice is separated from the ice maker 110 to be stored in the storage basket 210. Also (or alternatively), when the level of ice in the storage basket 210 is sensed as less than full, the ice maker 110 may be controlled to perform ice removal (S15).

FIG. 15 illustrates an example method of controlling a refrigerator when the refrigerating chamber door 12 is opened.

The first fan 53 and the second fan 140 are turned on so that the supply of cool air to the freezing chamber 16 and the ice making chamber 100 can be performed (S21).

In this state, it can be determined whether the refrigerating chamber door 12 is opened, by the operation of the door switch 70 (S22).

If the refrigerating chamber door 12 is sensed not to be opened, the first fan 53 and the second fan 140 continuously operate, and if the refrigerating chamber door 12 is sensed to be opened, the second fan 140 is turned off.

If the second fan 140 is turned off, the supply of cool air to the ice making chamber 100 is stopped, making it possible to reduce (e.g., prevent) the cool air from being unnecessarily leaked to the outside through the opened door (S23 and S24).

If the refrigerating chamber door 12 is opened, the ice making chamber 100 is separated from the ice storage part 200 so that ice removal from the ice maker 110 is stopped. Therefore, the ice removing motor 115 is controlled to be turned off (S25).

For convenience of explanation, the controlling method in FIG. 15 is explained to be separate from the controlling method in FIG. 14, but the controlling methods in FIGS. 14 and 15 may be simultaneously performed. For example, if any one of the separation of the storage basket 210 and the opening of the refrigerating chamber door 12 is made, the driving of the ice removing motor 115 can be controlled.

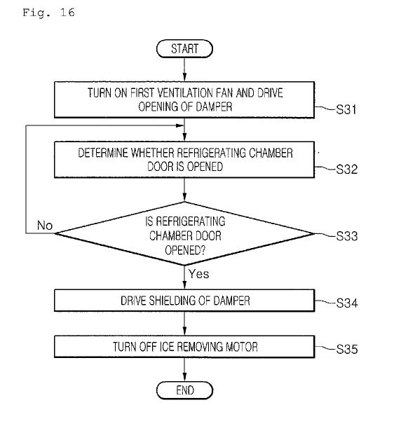

FIG. 16 illustrates an example method of controlling a refrigerator.

In FIG. 16, a method of controlling the damper 90 and the ice removing motor 155 according to the opening of the refrigerating chamber door 12 is shown.

In a state where the refrigerating chamber door is closed, the first fan 53 is driven and the damper 90 is opened so that at least a portion of the cool air generated in the first heat-exchanger 51 can be supplied to the ice maker 110 through the cool air duct 56 (S31).

In this state, it can be determined whether the refrigerating chamber door 12 is opened, by the door switch 70 (S32).

If the refrigerating chamber door 12 is sensed not to be opened, the driving of the first fan 53 and the opening of the damper 90 are continuously maintained, and, if the refrigerating chamber door 12 is sensed to be opened, the damper 90 is closed.

If the damper 90 is closed, the supply of cool air to the ice making chamber 100 is stopped, making it possible to reduce (e.g., prevent) the cool air from being unnecessarily leaked to the outside through the opened door (S33 and S34).

If the refrigerating chamber door 12 is opened, the ice making chamber 100 is separated from the ice storage part 200 so that ice removal from the ice maker 110 is stopped. Therefore, the ice removing motor 115 is controlled to be turned off (S35).

Meanwhile, the feature that the controlling part 300 controls the driving of the ice removing motor 115 depending on whether the storage basket 210 is attached or detached or whether ice therein is at a full level is similar to that described above (see FIG. 14).

With the refrigerator according to the constitution and operation as described above, whether the ice storage basket is attached or detached is sensed by the sensor or the switch, making it possible to easily control the ice removing time in the ice maker.

Moreover, the cool air supplied to the ice maker can be controlled depending on whether the refrigerating chamber door is opened or closed, making it possible to reduce (e.g., prevent) the cool air from being unnecessarily leaked to the outside.

Furthermore, when the refrigerator door is opened, the ice removing in the ice maker is stopped, making it possible to reduce (e.g., prevent) a phenomenon that the ice is discharged to the outside of the refrigerator.

What is claimed is:

1. A method of controlling a refrigerator, comprising:
controlling a fan to promote movement of cool air to an ice making chamber in which an ice maker is installed;
controlling the ice maker to freeze liquid water into ice;
using a sensing apparatus to sense whether an ice storage basket is attached or detached at a door that is configured to open and close at least a portion of a storage chamber in which the ice making chamber is positioned;
determining whether the ice storage basket is attached or detached at the door based on results of the sensing by the sensing apparatus; and
driving a first ice removing motor to remove ice made in the ice maker to the ice storage basket conditioned on a determination that the ice storage basket is sensed as being attached at the door by the sensing apparatus.

2. The method of controlling the refrigerator according to claim 1, wherein using the sensing apparatus to sense whether the ice storage basket is attached or detached at the door comprises determining whether a signal transmitted by a transmitting part is received by a receiving part.

3. The method of controlling the refrigerator according to claim 1, wherein using the sensing apparatus to sense whether the ice storage basket is attached or detached at the door comprises determining whether a sensing member and a contact member contact.

4. The method of controlling the refrigerator according to claim 1, further comprising:
controlling a door sensing apparatus to sense whether the door is oriented in an opened position or a closed position; and
determining whether the door is oriented in the opened position or the closed position based on results of the sensing by the door sensing apparatus,
wherein controlling the fan to promote movement of cool air to the ice making chamber comprises controlling the fan to promote movement of cool air to the ice making chamber conditioned on a determination that the door is oriented in the closed position.

5. The method of controlling the refrigerator according to claim 1, comprising:
controlling a door sensing apparatus to sense whether the door is oriented in an opened position or a closed position;
determining whether the door is oriented in the opened position or the closed position based on results of the sensing by the door sensing apparatus; and
controlling an open/close member to open a passage that supplies cool air to the ice making chamber conditioned on a determination that the door is oriented in the closed position.

6. The method of controlling the refrigerator according to claim 1, further comprising:
controlling a door sensing apparatus to sense whether the door is oriented in an opened position or a closed position;
determining whether the door is oriented in the opened position or the closed position based on results of the sensing by the door sensing apparatus;
controlling the first ice removing motor to be turned off irrespective of the determination of whether the ice storage basket is attached or detached in response to a determination that the door is oriented in the opened position.

7. The method of controlling the refrigerator according to claim 1, further comprising:
driving a second ice removing motor to dispense ice stored in the ice storage basket through the door conditioned on a determination that the ice storage basket is sensed as being attached at the door by the sensing apparatus.

8. A method of controlling a refrigerator, comprising:
controlling an ice maker to freeze liquid water into ice;
sensing a level of ice stored in an ice storage basket configured to store ice made by the ice maker;
determining whether the ice storage basket is full of ice based on the sensed level of ice stored in the ice storage basket;
sensing a position of the ice storage basket at a door that is configured to open and close at least a portion of a storage chamber in which the ice maker is positioned;
determining whether the ice storage basket is attached or detached at the door based on the sensed position of the ice storage basket; and
driving an ice removing motor to remove ice made in the ice maker to the ice storage basket conditioned on a determination that the ice storage basket is attached at the door and a determination that the ice storage basket is not full of ice.

9. The method of controlling the refrigerator according to claim 8, wherein sensing the level of ice stored in the ice storage basket configured to store ice made by the ice maker comprises controlling a transmitting part to transmit a signal across the ice storage basket toward a receiving part, and
wherein determining whether the ice storage basket is full of ice based on the sensed level of ice stored in the ice storage basket comprises determining that the ice storage basket is full of ice when the transmitted signal is not received by the receiving part.

10. The method of controlling the refrigerator according to claim 8, further comprising:
controlling a door sensing apparatus to sense whether the door is oriented in an opened position or a closed position;
determining whether the door is oriented in the opened position or the closed position based on results of the sensing by the door sensing apparatus; and
controlling the ice removing motor to be turned off irrespective of the determination of whether the ice storage basket is full of ice in response to a determination that the door is oriented in the opened position.

11. A method of controlling a refrigerator, comprising:
controlling an ice maker to freeze liquid water into ice;
controlling a transmitting part to transmit a signal;
determining whether a receiving part receives the signal transmitted from the transmitting part; and
determining, using a controller, whether an ice storage basket is positioned to receive ice made by the ice maker and whether the ice storage basket is full of ice based on the determination of whether the receiving part receives the signal transmitted from the transmitting part.

12. The method of controlling the refrigerator according to claim 11, further comprising:
driving an ice removing motor to remove ice made in the ice maker to the ice storage basket in response to a determination that the ice storage basket is positioned to receive ice made by the ice maker and the ice storage basket is not full of ice.

13. The method of controlling the refrigerator according to claim 11, further comprising:
driving an ice removing motor to dispense ice stored in the ice storage basket to an outside of the refrigerator conditioned on a determination that the ice storage basket is positioned to receive ice made by the ice maker.

14. The method of controlling the refrigerator according to claim 11, further comprising:
driving a fan to promote movement of cool air to the ice maker conditioned on a determination that the ice storage basket is positioned to receive ice made by the ice maker.

15. The method of controlling the refrigerator according to claim 11, further comprising:
controlling an open/close member to open a passage that supplies cool air to the ice maker conditioned on a determination that the ice storage basket is positioned to receive ice made by the ice maker.

16. The method of controlling the refrigerator according to claim 11, further comprising:
controlling a door sensing apparatus to sense whether a refrigerator door is oriented in an opened position or a closed position;
determining whether the refrigerator door is oriented in the opened position or the closed position based on results of the sensing by the door sensing apparatus; and
driving an ice removing motor to remove ice made in the ice maker to the ice storage basket conditioned on a determination that the refrigerator door is oriented in the closed position, a determination that the ice storage basket is positioned to receive ice made by the ice maker, and a determination that the ice storage basket is not full of ice.

17. The method of controlling the refrigerator according to claim 11, further comprising:
controlling a door sensing apparatus to sense whether a refrigerator door is oriented in an opened position or a closed position;
determining whether the refrigerator door is oriented in the opened position or the closed position based on results of the sensing by the door sensing apparatus; and
driving an ice removing motor to dispense ice stored in the ice storage basket to an outside of the refrigerator conditioned on a determination that the refrigerator door is oriented in the closed position and a determination that the ice storage basket is positioned to receive ice made by the ice maker.

18. The method of controlling the refrigerator according to claim 11, further comprising:
controlling a door sensing apparatus to sense whether a refrigerator door is oriented in an opened position or a closed position;
determining whether the refrigerator door is oriented in the opened position or the closed position based on results of the sensing by the door sensing apparatus; and
driving a fan to promote movement of cool air to the ice maker conditioned on a determination that the refrigerator door is oriented in the closed position and a determination that the ice storage basket is positioned to receive ice made by the ice maker.

19. The method of controlling the refrigerator according to claim 11, further comprising:
controlling a door sensing apparatus to sense whether a refrigerator door is oriented in an opened position or a closed position;
determining whether the refrigerator door is oriented in the opened position or the closed position based on results of the sensing by the door sensing apparatus; and
controlling an open/close member to open a passage that supplies cool air to the ice maker conditioned on a determination that the refrigerator door is oriented in the closed position and a determination that the ice storage basket is positioned to receive ice made by the ice maker.

20. A method of controlling a refrigerator, comprising:
controlling a fan to promote movement of cool air to an ice making chamber in which an ice maker is installed;
controlling the ice maker to freeze liquid water into ice;
using a first sensing apparatus to sense whether an ice storage basket is attached or detached at a door that is configured to open and close at least a portion of a storage chamber in which the ice making chamber is positioned;
using the first sensing apparatus to sense whether the ice storage basket is full of ice;
using a second sensing apparatus to sense whether the door is oriented in an opened position or a closed position;
driving a first ice removing motor to remove ice made in the ice maker to the ice storage basket conditioned on the second sensing apparatus sensing that the door is oriented in the closed position and the first sensing apparatus sensing that the ice storage basket is not full of ice; and
driving a second ice removing motor to dispense ice stored in the ice storage basket to the through the door conditioned on the first sensing apparatus sensing that the ice storage basket is attached at the door.
